(19) United States
(12) Patent Application Publication
(10) Pub. No.: US 2015/0059664 A1
(43) Pub. Date: Mar. 5, 2015

(54) System and Method for Generating Electricity from Water

(71) Applicants: Christopher S. Roys, Conway, AR (US); Phillip Marco Roys, Hitchcock, TX (US)

(72) Inventors: Christopher S. Roys, Conway, AR (US); Phillip Marco Roys, Hitchcock, TX (US)

(21) Appl. No.: 14/018,892

(22) Filed: Sep. 5, 2013

(51) Int. Cl. F02B 43/10; F02M 31/20; F02B 43/12; F02M 31/18; F02B 63/04; F02B 51/04

(52) U.S. Cl. CPC F02B 43/10; F02B 63/04; F02B 51/04; F02B 43/12; F02M 31/18; F02M 31/20; F02B 2043/106
USPC 123/3

(57) ABSTRACT

A method and system for generating electricity from water, which includes the steps of passing water from a water source to a holding tank; heating the water, thereby generating steam; cooling the steam, thereby generating distilled water; splitting the distilled water into hydrogen and oxygen; powering an engine with the hydrogen, wherein the engine is coupled to a generator; and powering the generator with the engine, thereby generating electricity for distribution from the generator.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

The present invention relates generally to a system and method for generating electricity, and more specifically to a system and method for generating electricity from water.

2. Brief Description of the Related Art

The use of water (and its component hydrogen) as a sustainable energy source has long been a topic of research. For example, hydrogen fuel cells have been developed for automobiles. The inventors have developed an improved scalable system for generating electricity from water that can be used in a broad range of applications.

### BRIEF SUMMARY OF THE INVENTION

The present invention is directed to a method for generating electricity from water, which includes the steps of passing a quantity of water from a water source to a holding tank; heating the quantity of water, thereby generating steam; cooling the steam, thereby generating distilled water; splitting the distilled water into hydrogen and oxygen; powering an engine with the hydrogen, wherein the engine is coupled to a generator; and powering the generator with the engine, thereby generating electricity for distribution by the generator.

The present invention is also directed to a system for generating electricity from water, which includes a water source; a first tank holding a quantity of undistilled water from the water source; means for heating the quantity of water; a condenser unit; a second tank holding a quantity of distilled water; a water conversion unit operable to split the distilled water into a quantity of hydrogen and a quantity of oxygen; a tank for holding the quantity of hydrogen; an engine powered by a portion of said quantity of hydrogen; and a generator coupled to the engine, wherein said generator generates electricity for distribution.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a schematic illustrating the system and method of the present invention. The flow of the water, the oxygen, and the hydrogen within the system is shown by the arrows.

### DETAILED DESCRIPTION OF THE INVENTION

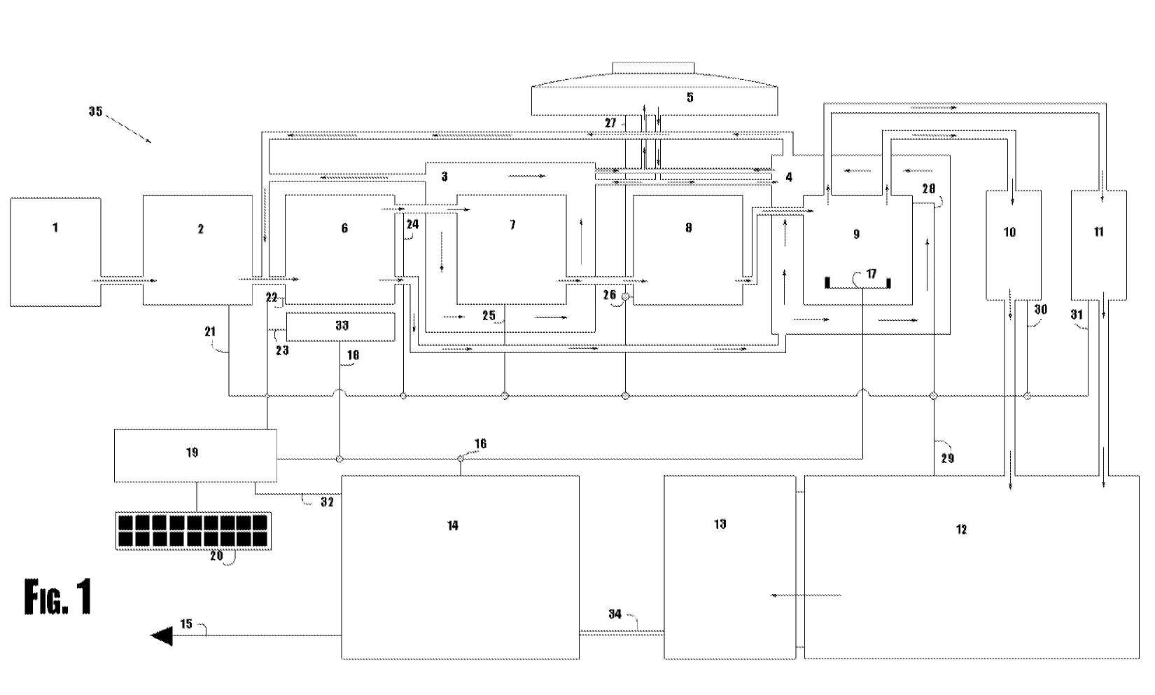

With reference to FIG. 1, the preferred embodiments of the present invention may be described. The system 35 of the present invention is a self-contained system for generating electricity from water that can be used in various applications, including powering houses, factories, and remote sites having little or no access to the traditional electricity infrastructure. The system 35 is scalable depending on electricity demands.

A water source 1 supplies water through a water input to a water desalination unit 2, resulting in fresh water. Depending on the water source 1, the desalination unit 2 may not be utilized in the system. The desalination unit 2 removes salt and other impurities from the water and preferably is of a type that would be well-known to those skilled in the art. The fresh water is then received by a water heating tank 6, a condenser unit housing 3 and a water conversion unit housing 4. The condenser unit housing 3 surrounds the condenser unit 7 and the water conversion unit housing 4 surrounds the water conversion unit 9. The water in the condenser unit housing 3 and the water conversion unit housing 4 is used to cool the condenser unit 7 and the water conversion unit 9. If cooling is not necessary, the fresh water may be routed only to the heating tank 6. Because of its cooling purposes, the water coming from the water source 1 is preferably at room temperature or colder.

The water routed through the water heating tank 6 is heated to boiling temperatures by a heating source 33 to create steam. The heating source 33 is preferably electrically heated coils or a flame source. The condenser unit 7 then cools the steam to create distilled water, which is stored in the distilled water holding tank 8. The water conversion unit 9 uses the distilled water to split the water molecules (H₂O) into its component parts (two hydrogen atoms and one oxygen atom). The water conversion unit 9 may, for example, be an electrolysis unit 17 utilizing an anode and a cathode separated by an ion exchange membrane. It should be understood, however, that any water splitting apparatus that would be known to those skilled in the art could be utilized in the system. The resulting hydrogen from the water splitting process is stored in a hydrogen storage unit 10 and the resulting oxygen is stored in an oxygen storage unit 11. The hydrogen storage unit 10 and the oxygen storage unit 11 may be pressurized.

For further cooling, the water in the condenser unit housing 3 and water conversion unit housing 4 may be passed through a recirculation radiator 5 and then back to the condenser unit housing 3 and water conversion unit housing 4. In addition to cold water in the water conversion unit housing 4, a mechanical fan may also be used to cool the water conversion unit 9. The water in the condenser unit housing 3 and water conversion unit housing 4 may also be passed back to the water heating tank 6 to participate in the distillation process described above.

The hydrogen stored in the hydrogen storage unit 10 is used to power a hydrogen-powered internal combustion engine 12 in the system 35. The engine 12 is preferably of a type that would be well-known to those skilled in the art. The hydrogen is used as the primary combustible fuel source in the stoichiometric fuel mixture. In one embodiment, the oxygen stored in the oxygen storage unit 11 is added to the engine 12 during the intake phase to increase the oxygen level of the air mixture. The oxygen stored in the oxygen storage unit 11 may also be used to supplement the heating source for the water in the distillation process.

The engine 12 is coupled (directly or indirectly) to an electrical generator 13. The generator 13 creates electricity that may be distributed and used inside and outside the system. The generator 13 is preferably of a type that would be well-known to those skilled in the art. The electricity is fed through electrical bus 34 into an electrical distribution panel 14, which provides electrical power to the primary electrical load 15 and other parts of the system 35 through electrical junction 16. Examples of the primary electrical load are portable generators, houses, commercial properties, industrial properties and sea-going vessels. A control panel 19 is also powered by electricity from the distribution panel 14 through electrical connector 32. The control panel 19 is used to control the voltages and electrical requirements of the various components of the system 35. The control panel 19 is coupled to and monitors, charges, senses, and regulates these components of the system 35 in a feedback mechanism through electrical connectors 18, 21, 22, 23, 24, 25, 26, 27, 28, 29, 30, 31. The electrical connectors are preferably of a type that would be well-known those skilled in the art, such as cooper conductors. The system may utilize multiple control panels 19. The control panel 19 may also be powered by a solar array 20, which converts solar energy to electricity to power the control panel and thus decrease the load on the system 35.

A partial loss of the total electrical output of the system occurs because some of the electricity is consumed by the system 35 itself. The various components of the system 35 are connected via a network of electrical connectors referenced above and electrical junctions (like 26), which allow the passage of electricity throughout the system 35. The electrical connectors within the system 35 may function as the primary electrical feed to the various components of the system or function as the control circuit that is used to monitor and regulate the various components, such as a temperature probe or water pressure monitor. This partial loss is primarily caused by the electricity required to operate the heating source 33 and the water conversion unit 17.

The present invention has been described with reference to certain preferred and alternative embodiments that are intended to be exemplary only and not limiting to the full scope of the present invention as set forth in the appended claims.

We claim:

1. A method for generating electricity from water, comprising the steps of:
(a) passing a quantity of water from a water source to a holding tank;
(b) heating said quantity of water, thereby generating steam;
(c) cooling said steam, thereby generating a quantity of distilled water;
(d) splitting said distilled water into a quantity of hydrogen and a quantity of oxygen;
(e) powering an engine with a portion of said quantity of hydrogen, wherein said engine is coupled to a generator; and
(f) powering said generator with said engine, thereby generating electricity for distribution from said generator.

2. The method of claim 1, wherein said step of splitting said distilled water into hydrogen and oxygen comprises the step of using electrolysis.

3. The method of claim 1, further comprising the step of storing said quantity of hydrogen in a hydrogen storage unit and said quantity of oxygen in an oxygen storage unit.

4. A system for generating electricity from water, comprising:
(a) a water source;
(b) a first tank holding a quantity of undistilled water from said water source;
(c) means for heating said quantity of undistilled water;
(d) a condenser unit;
(e) a second tank holding a quantity of distilled water;
(f) a water conversion unit operable to split said quantity of distilled water into a quantity of hydrogen and a quantity of oxygen;
(g) a tank for holding said quantity of hydrogen;
(h) an engine powered by a portion of said quantity of hydrogen; and
(i) a generator coupled to said engine, wherein said generator generates electricity for distribution.

5. The system of claim 4, wherein said means for heating is a set of heating coils.

6. The system of claim 4, wherein said condenser unit is surrounded by a housing filled with a quantity of said undistilled water, wherein said undistilled water is cold.

7. The system of claim 4, wherein said water conversion unit is surrounded by a housing filled with a quantity of said undistilled water, wherein said undistilled water is cold.

8. The system of claim 4, further comprising a radiator.

9. The system of claim 4, further comprising a tank for holding said quantity of oxygen.

10. The system of claim 4, further comprising an electrical distribution panel.

11. The system of claim 4, further comprising a control panel.

12. The system of claim 4, wherein said control panel is powered by a solar array.
